(19) United States
(12) Patent Application Publication
(10) Pub. No.: US 2007/0141464 A1
(43) Pub. Date: Jun. 21, 2007

(54) Porous metal hydride electrode

(76) Inventors: Qunjian Huang, Shanghai (CN); John Patrick Lemmon, Schoharie, NY (US); Richard Louis Hart, Niskayuna, NY (US); Shengxian Wang, Shanghai (CN); Chang Wei, Niskayuna, NY (US); Qijia Fu, Shanghai (CN); Hai Yang, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/314,252

(22) Filed: Dec. 21, 2005

(51) Int. Cl. H01M 4/58; H01M 8/06

(52) U.S. Cl. 429/218.2; 252/182.1; 429/19

(57) ABSTRACT

An electrode for use in a fuel cell or a battery is provided. The electrode may include a porous main body that may include a metal hydride defining a pore volume effective for preventing water starvation in the fuel cell or battery. An associated method for making and/or using is provided.

### FIELD

Embodiments of the invention may relate to an electrode, a fuel cell that may include the electrode, method embodiments for making the electrode and method embodiments for making the fuel cell that may include the electrode.

### BRIEF DESCRIPTION

One embodiment of the invention may include a porous electrode for use in a fuel cell or a battery. The porous electrode may include a porous main body comprising a metal hydride defining a pore volume effective for preventing water starvation in the fuel cell or battery.

An embodiment may include a method for making a porous electrode. The method may include mixing a metal hydride and sacrificial material to form a mixture. The method may include applying the mixture to metal foam to form an anode main body. The method additionally may include removing the sacrificial material from the sintered main body to form the porous electrode.

An embodiment may include an electrode precursor. The electrode precursor may include a main body including a metal hydride and a sacrificial additive. The sacrificial additive may be disposed in the main body to define an inner surface of the main body and further to define a pore volume. The sacrificial additive may be present in an amount sufficient that, when removed, the pore volume of the main body is of sufficient volume to prevent or reduce water starvation in a fuel cell or in a battery

A system is provided for forming an electrolyte and/or water reservoir. The system may be used in a fuel cell or battery.

### BACKGROUND

Fuel cells may convert chemical to electrical energy. The electrical energy can be used for both transportation and stationary applications. With respect to stationary applications, fuel cells represent a promising alternative or addition to batteries. Batteries may have an undesirably short operating time between charges relative to fuel cells. Primary batteries may be single use, and secondary batteries may be rechargeable.

Chemical batteries may convert less than the full potential of the energy contained in chemicals within the batteries to electrical energy. Relatively, hydrogen fuel cell powered devices may be more efficient. The fuel cells may utilize more of the chemical fuel's energy.

A fuel cell may create electrical energy through a chemical process that converts hydrogen fuel and oxygen into water, and back again. Heat and electricity may be produced in the process. While batteries may be recharged using electricity, fuels cells may be recharged by adding more chemical fuel. Rechargeable fuel cells may convert hydrogen to water and electricity during discharging, and may convert electricity and water into hydrogen during the charging process. Water is used as an energy conversion medium for both conversion reactions. A theoretical water balance between charging and discharging may be problematic to achieve and/or maintain under working conditions, however, because of losses due to evaporation and consumption from the fuel cell. The water loss from the system may pose a problem for continuous operation of a rechargeable fuel cell.

It may be desirable to have a fuel cell and/or a metal/air battery having differing components, characteristics or properties than those currently available.

### BRIEF DESCRIPTION OF DRAWINGS

Throughout the drawings, like elements are given like numerals. Wherein:

FIG. 1 is a cross-sectional view of one embodiment of a rechargeable fuel cell.

FIG. 2 is a schematic view of a fabrication process for making a porous metal hydride anode embodiment.

FIG. 3 is a schematic view of a fabrication process for making a porous metal hydride anode embodiment.

FIG. 4 is a micrograph view of a porous metal hydride anode embodiment.

FIG. 5 is a graphical view of electrolytes retained in a porous metal hydride anode embodiment.

FIG. 6 is a schematic view of another fabrication process for making a porous metal hydride anode embodiment.

FIG. 7 is a cross sectional view of one embodiment of a porous electrode.

FIGS. 8A and 8B are top views of intermediate process forms of the porous electrode, before and after calcination.

FIGS. 9A and 9B are other embodiments of top views of intermediate process forms of the porous electrode, before and after calcination.

FIG. 10 is a schematic view of another fabrication process for making a porous metal hydride anode embodiment.

FIG. 11 is a graphical view of electrolytes retained in a porous metal hydride anode embodiment.

### DETAILED DESCRIPTION

Embodiments of the invention may relate to an electrode, a fuel cell that may include the electrode, method embodiments for making the electrode and method embodiments for making the fuel cell that may include the electrode.

Although detailed embodiments of the invention are disclosed herein, the disclosed embodiments are merely exemplary of the invention that may be embodied in various and alternative forms. Specific structural and functional details disclosed herein are not to be interpreted as limiting, but merely a basis for the claims for teaching one of ordinary skill in the art to variously employ the porous metal hydride electrode invention embodiments.

As used herein, the term membrane may refer to a selective barrier that permits passage of hydroxide ions generated at a cathode through the membrane to the anode for oxidation of hydrogen atoms at the anode to form water and heat. The terms cathode and cathodic electrode refer to a metal electrode that may include a catalyst. At the cathode, or cathodic electrode, oxygen from air is reduced by free electrons from the usable electric current, generated at the anode, that combine with water, generated by the anode, to form hydroxide ions and heat.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

Electrochemical cell embodiments, as is used herein, refer to assemblies of two electrodes connected by an electrolyte which forms a ion path between the electrodes. Electrochemical cells include voltaic cells, and batteries. Fuel cells, including rechargeable fuel cells and metal air batteries, and their stacks, are also types of electrochemical cell embodiments.

In one aspect, the porous metal hydride anode may be useful in a fuel cell portion of a rechargeable fuel cell or in a rechargeable battery portion. The porous metal hydride anode may be useful in metal hydride-based batteries.

Rechargeable fuel cells of large capacitance may need one or more water storage reservoirs. One water storage reservoir may include aqueous electrolyte. The reservoir may be disposed in fluid communication with the anode and the cathode of a fuel cell. However, this single reservoir may not, by itself, be sufficient to meet the water storage needs of a large capacitance rechargeable fuel cell. Embodiments of the invention described herein include a water reservoir in addition to, or as an alternative to, a standard reservoir in the form of the volume defined by the pores in a porous anode electrode. Porous metal anode embodiments described herein define a pore volume that is effective for storing a volume sufficient to replace water lost from rechargeable fuel cells due to evaporation and/or consumption. Porous metal anode use may relatively improve charge efficiency by reducing electrolyte transfer. Porous anode embodiments simplify rechargeable fuel cell design. In one embodiment, a porous anode electrode embodiment may improve charging efficiency, may relatively increase a water storage volume, and may aid in water management in a fuel cell.

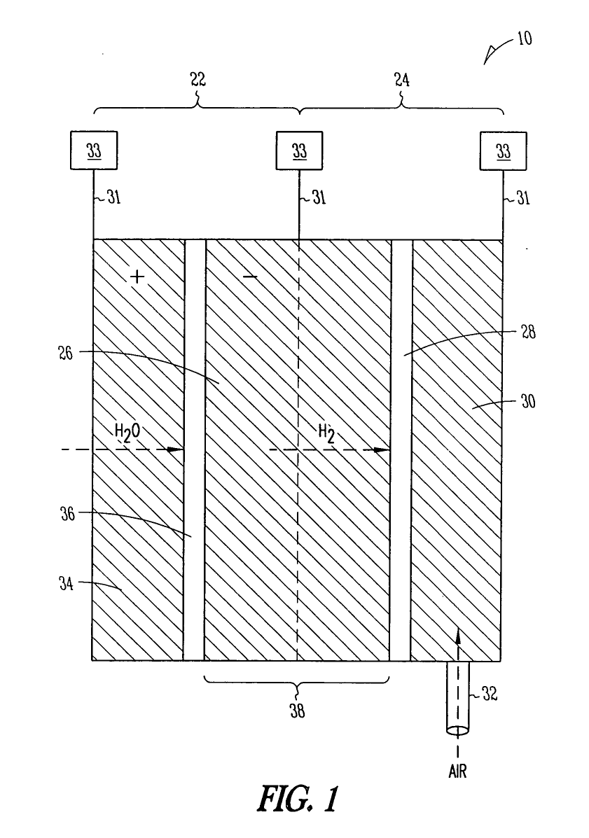

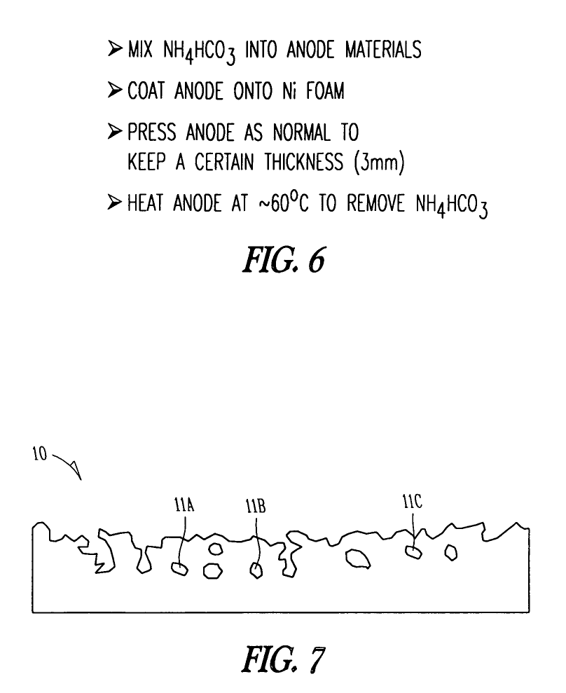

With reference to FIGS. 1 and 7, embodiments of the porous metal hydride anode include a main body 10. The main body 10 may have an inner surface that defines a plurality of pores, such as pores 11A, 11B and 11C. A fuel cell 20 may include the porous metal hydride anode. The rechargeable fuel cell 20 may include a hydrogen generator component 22 and a fuel cell component 24, the components may be structurally and operationally connected via a common electrode. The main body 10 may serve as the negative electrode 26. The rechargeable fuel cell also may include a fuel cell cathode 28, which may be the positive electrode.

The anode 26 and the cathode 28 may be spatially separate from one another by an electrolyte. In one embodiment, the electrolyte may be contained in, or supported by, a matrix that may wick the electrolyte over a surface of the electrode. Water may be used as an energy conversion medium in the operation of the rechargeable fuel cell. Water is, for some embodiments, stored as a component of a KOH aqueous electrolyte solution between the anode 26 and cathode 28. In the invention embodiment described herein, the water may be additionally stored in the porous negative electrode 26. The rechargeable fuel cell 20 may include a membrane 30 for some embodiments.

Although the fuel cell structure and materials may differ from embodiment to embodiment, in one embodiment the fuel cell component 24 may be a galvanic energy conversion device that chemically combines hydrogen and an oxidant within catalytic confines to produce a DC electrical output. In one form of the fuel cell, the fuel cell cathode 28 and material may define passageways for the oxidant, and the negative electrode 26 and materials may define the passageways for the fuel cell fuel. The cathode 28 may be a micro-porous structure through which liquids will not readily or freely flow, but through which oxygen, under pressure, may be fed to support the chemical reaction within the fuel cell component 24. An oxygen-containing gas may be fed into the fuel cell cathode 28 through a cathode supply line 32. In one embodiment, ambient air may be the source of the oxygen.

Electrolyte spatially separates the fuel cell cathode 28 and negative electrode 26. The electrolyte may conduct negatively charged ions while blocking electrons. Fuel cells employing a non-woven separation membrane 30 may operate at relatively low temperatures, such as about 100 degrees Celsius, due to the limitations imposed by the thermal properties of the membrane materials.

As discussed further hereinbelow, the main body 10 may be made by mixing metal hydride powder with one or more conductive additives and preselected amounts of sacrificial additives such as Al, Zn, NH₄HCO₃, nickel acetate. For some embodiments, a gel binder is also added to form a mixture.

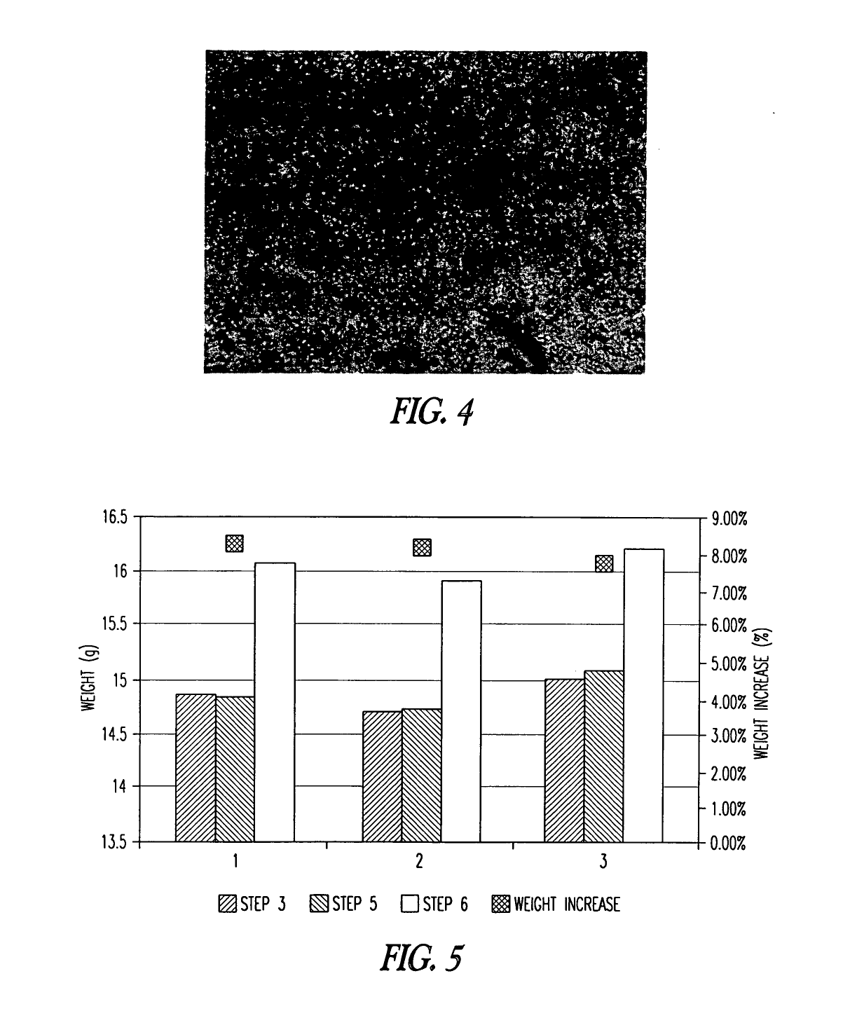

The fuel cell component may derive hydrogen from a solid-state material and water, or from another hydrogen source. The porous metal hydride anode of the fuel cell may be operable for conducting electrons freed from the solid-state hydrogen storage material so that they can be supplied to the current collectors 31. The porous metal hydride anode 26 may include pores, (see, for example, FIG. 4) and interstitial spaces that are operable for storing water and electrolyte. The porous metal hydride anode 26 has an improved charge efficiency occurring as a result of reducing electrolyte transfer. The porosity creates a volume within the anode for storage of water and electrolyte, which may be effective for off-setting water losses due to evaporation and consumption. Water retained in one porous metal hydride anode fabricated using zinc powder by a sintering process may be shown graphically in FIG. 5.

The fuel cell cathode 28 may be further operable for conducting electrons back from an external circuit to the catalyst, where they combine with water and oxygen to form hydroxide ions. The catalyst may be operable for facilitating the reaction between hydrogen and oxygen. The catalyst may comprise materials including, but not limited to, platinum, palladium and ruthenium, which face the membrane 30. The surface of the platinum may be such that a maximum amount of the surface area may be exposed to oxygen. Oxygen molecules are dissociated into oxygen atoms in the presence of the catalyst and accept electrons from the external circuit while reacting with hydrogen atom, thus forming water. In this electrochemical reaction, a potential develops between the two electrodes.

The hydrogen-generating component 22 of the hybrid system provides energy storage capacity and shares the porous anodic electrode 26 of the fuel cell component 24. The hydrogen-generating component 22 further may include electrode 34 and separator 36. The structure of the hydrogen-generating component 22 may be a construction including one or more identical cells, with each cell include at least one each of an electrode 34, anodic electrode 26, and separator 36. The anodic porous electrode 26 may include hydrogen storage material 38 and may perform one or more functions, such as: (1) a solid-state hydrogen source for the fuel cell component 24; (2) an active electrode 26 for the hydrogen-generating component 22; and (3) a portion or all of the electrode functions as an anode of the anode component 24.

The electrochemical hydrogen-generating component 22 has storage characteristics characterized by being capable of accepting direct-current (DC) electrical energy in a charging phase to return the solid-state material to a hydrogen-rich form, retaining the energy in the form of chemical energy in the charge retention phase, and releasing stored energy upon a demand by the fuel cell component 24 in a discharge phase. The hydrogen-generating component 22 may repeatedly perform these three phases over a reasonable life cycle based on its rechargeable properties. The electrical energy may be supplied from an external source, a regenerative braking system, as well as any other source capable of supplying electrical energy. The solid state material may be recharged with hydrogen by applying the external voltage.

Suitable metal hydrides may include one or more of AB₅ alloy, AB₂ alloy, AB alloy, A₂B alloy, A₂B₁₇ alloy, or AB₃ alloy. The AB₅ alloy may include, but is not limited to, LaNi₅, CaNi₅, or MAₓB_{y}C_{z}, wherein M may be a rare earth element component; A is one of the elements Ni or Co; B may be one of the elements Cu, Fe or Mn; (it is noted that as used herein “C” does not stand for elemental carbon) C may be one of the elements Al, Cr, Si, Ti, V or Sn. And, x, y and z satisfy one of the following relations, wherein 2.2≦x≦4.8, 0.01≦y≦2.0, 0.01≦z≦0.6, or 4.8≦x+y+z≦5.4. Suitable examples of AB₂ include, but are not limited to, Zr—V—Ni, Zr—Mn—Ni, Zr—Cr—Ni, TiMn, and TiCr. Suitable AB type alloys include, but are not limited to, TiFe and TiNi. Suitable A₂B type alloys include, but are not limited to, Mg₂Ni. Suitable A₂B₁₇ type alloys include, but are not limited to, La₂Mg₁₇. Suitable AB₃ type alloys include, but are not limited to, LaNi₃, CaNi₃, and LaMg₂Ni₉.

In one embodiment, the anode material may include catalyzed complex hydrides. Suitable complex hydrides may include one or more of borides, carbides, nitrides, aluminides, or silicides. Suitable examples of complex catalyzed hydrides may include an alanate. Suitable alanates may include one or more of NaAlH₄, Zn(AlH₄)₂, LiAlH₄ and Ga(AlH₄)₃. Suitable borohydrides may include one or more of Mg(BH₄)₂, Mn(BH₄)₂ or Zn(BH₄)₂. In one embodiment, the anode material may include complex carbon-based structures or boron-based structures. Such complex carbon-based structures may include fullerenes, nanotubes, and the like. Such complex boron-based structures may include boron nitride (BN) nanotubes, and the like.

Sacrificial additives may be selected to control the pore volume and/or the pore configuration. For example, a weight of sacrificial additives may be selected to control pore volume. That is, the more of the sacrificial additive used, the more pore volume is generated when the sacrificial additive is removed. As another example, a type of sacrificial additive may be selected to control pore configuration. That is, the configuration of the sacrificial additive selected may control the pore configuration when the sacrificial additive is removed. The configuration may include such attributes as interconnectivity, diameter, length, spacing, and the like.

In one method embodiment 12 shown in FIG. 2, metal hydride powder may be mixed with a conductive additive. Suitable conductive additives may include, for example, nickel or cobalt.

A determined amount of sacrificial additives may be added to form a mixture. The amount may be determined with reference to the desired pore volume of the end product. That is, an amount of the sacrificial additives having a known volume may be used to produce a corresponding desired volume in the end product. Suitable sacrificial additives may include one or more of zinc, aluminum, nickel, or carbon. In one embodiment, the sacrificial additives may include one or more of zinc acetate, aluminum acetate, or nickel acetate. In one embodiment, the sacrificial additives may include a carbonate, such as NH₄HCO₃.

The mixture may be pasted, formed, and pressed to form an anode electrode precursor structure. The anode electrode precursor structure may be heated. The heating may calcine and/or sinter the precursor structure to form an electrode main body. The sacrificial additives may be partially or entirely removed during, or after, the sintering process. If removed during, generally the heat of calcining and/or sintering may vaporize the sacrificial additives. If removed after, the sacrificial additives may be solvated or the like. Excipient salts may be useful for solvated removal after heating. The removal of the sacrificial additives may leave a porous metal anode electrode main body 10 having a determined pore volume. A micrograph top view of an anode electrode main body is shown in FIG. 4.

In one embodiment, the sacrificial additive may be selected to have an effect on the inner surface of the pores formed by the removal of the sacrificial additive. In such an instance, the composition of the sacrificial additive may be entirely or partially devoted to affecting the surface character of the pore. For example, if a metal particle is added to the sacrificial additive, which is otherwise a low volatile polymer, heating to vaporize the sacrificial additive may release the metal particle from the matrix of the sacrificial additive and the metal particle may deposit on the pore inner surface. Thus, the pore inner surface composition and character may be controlled. In one embodiment, a material is deposited on the pore inner surface that readily forms surface hydroxyl groups. The surface hydroxyls may increase the hydrophilicity of the pores and facilitate transport of polar liquids therethrough. In one embodiment, a selected catalyst may be deposited on the pore inner surface. It may be desirable to coat the outer surface of the sacrificial additive, which will contact and define the inner surface of the pore, with the material to be deposited.

During use, the pores may receive and store water and/or electrolyte. Suitable electrolytes may include aqueous KOH. The anode electrode main body may have a pore volume capable of storing quantities of water and electrolyte suitable for use in a rechargeable fuel cell or a metal hydride based battery. The pore volume may be greater that about 5 percent of the volume of the anode electrode main body. In one embodiment, the pore volume may be in a range of from about 5 percent to about 10 percent, from about 10 percent to about 15 percent, from about 15 percent to about 20 percent, from about 20 percent to about 25 percent, from about 25 percent to about 35 percent, from about 35 percent to about 45 percent, from about 45 percent to about 55 percent, or from about 55 percent to about 75 percent of the volume of the anode electrode main body.

Embodiments of the porous metal hydride anode may have a relatively improved charge efficiency resulting from a reduced electrolyte transfer. Electrolyte transfer may refer to the tendency of the electrolyte to migrate from the positive end proximate the cathode to the negative end proximate the anode during use. In a stack, particularly, the end cells may lose performance relative to the centrally located cells from such migration, which may cause a concentration imbalance. By providing a physical obstacle to flow, in the form of a tortuous path and constricted pathways, electrolyte migration may be controlled, and thereby electrolyte transfer may be reduced.

Porous metal hydride electrode embodiments thus can store additional KOH electrolyte and can serve as anodes after being positioned with a membrane separator, air cathode electrode and other components and assembled into a rechargeable fuel cell. The additional quantity of KOH electrolyte stored in porous anode embodiments such as are shown at 10 and in FIG. 4 can reduce the water management concerns caused by the consumption and evaporation of water during the charge and discharge process. At the same time, the use of porous anode embodiments in a rechargeable fuel cell improves the energy conversion and energy transfer efficiency of the fuel cell. The porous anode is also usable in fuel cells that are not rechargeable.

In one aspect, an embodiment may include a method for making a porous anode for use in a rechargeable fuel cell. The method 12 may include, as illustrated schematically in FIG. 2, preparing a mixture that may include metal hydride and one or more sacrificial additives. For some embodiments, a gel binder may be added as part of the sacrificial additive. The additives may be sacrificial insofar as they may be subsequently removed during sintering, completely or in part, to form the pores in the porous anode.

The metal hydride and sacrificial additive mixture may be formed into a porous electrode main body, or green body. The green body may be sintered as shown at block 16 in FIG. 2. Sintering may obtain a stable and strong connection among the metal hydride particles. Hydrogen gas may be introduced during the sintering to reduce or prevent metal hydride oxidation. The sacrificial additive may be introduced during mixing, and may be removed during sintering. Alternatively, the sacrificial additive may be removed by other removal steps without sintering.

The metal hydride and sacrificial additive mixture may be paste sintered. In this paste sintered embodiment, a mixture of metal hydride and sacrificial additive may coat a metal foam plate, and may be paste sintered at high temperature.

In one embodiment for paste sintering, a nickel metal hydride may be mixed with a zinc sacrificial additive, forming a metal hydride mixture. The metal hydride mixture may be applied to a nickel foam. The wet coated nickel foam plate may be dried to form an electrode main body. The main body may be sintered at about 800 degrees Celsius. In one embodiment, the metal hydride mixture may be mixed further with a binder. Suitable binders may include styrene butadiene rubber and nickel. The mixed composition may be cold pressed onto the nickel foam plate to form a cold pressed assembly. The cold press assembly may be cold press sintered at a lower temperature than the temperature used for paste sintering.

The temperature range for paste sintering may be from about 100 degrees Celsius to about 800 degrees Celsius. The temperature range for cold press sintering may be in a range of from about 100 to about 300 degrees Celsius. Binders such as gel binders, styrene butadiene rubber, and carboxymethyl cellulose may be added to the cold press assembly and may be sintered at a temperature in a range of from about 500 degrees Celsius to about 800 degrees Celsius. Sacrificial additives may be added to the mixture before it is formed green structure, which may be further processed to become the electrode main body.

The sintered anodes may be treated (block 18) to remove sacrificial additives, FIG. 2. The treatment may include sonication, acidification, solvation, or dissolution by heat decomposition. Additive removal schemes for removing additives in an alkaline environment with sonication include treating with zinc or aluminum as follows:
Zn+2OH⁻→ZnO₂⁻+H₂
Al+2OH⁻→AlO₂⁻+H₂
The treatment with an alkaline material forms Zn and Al ionic species, which may be washed away.

Additive removal schemes for removing additives in an acidic environment with sonication may include treating with zinc or aluminum or ammonium carbonate as follows:
Zn+2H⁺→Zn²⁺+H₂
Al+2H⁺→Al³⁺+H₂
When Zn and Al are exposed to an acidic environment, zinc ion and aluminum ion, respectively, may be formed with hydrogen gas.

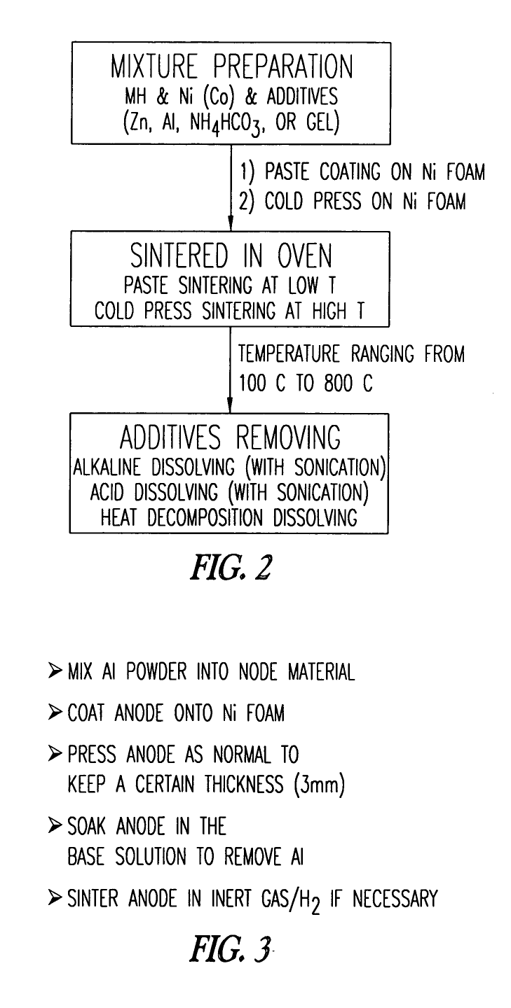

In one method embodiment 44 in FIG. 3, a sacrificial additive of aluminum powder may be mixed into anodic metal hydride material to form a mixture. The mixture may be coated onto a nickel foam and pressed to form an anode having a thickness of, in one embodiment, about 3 mm. The anode may be soaked in an alkaline solution to remove the aluminum. The soaked anode may be sintered in a mixture of argon gas and hydrogen gas, for some embodiments. For other embodiments, the anode may be not sintered.

Another method embodiment may be shown at 46 in FIG. 6. This embodiment may include mixing NH₄HCO₃ into anodic metal hydride material, coating the mixture onto nickel foam and pressing to form an anode. In one embodiment, the thickness of an anode may be about 3 mm. The pressed anode may be heated at a temperature of about 60 degrees Centigrade to remove the NH₄HCO₃ with the removal scheme below.
NH₄HCO₃→NH₃+CO₂+H₂O

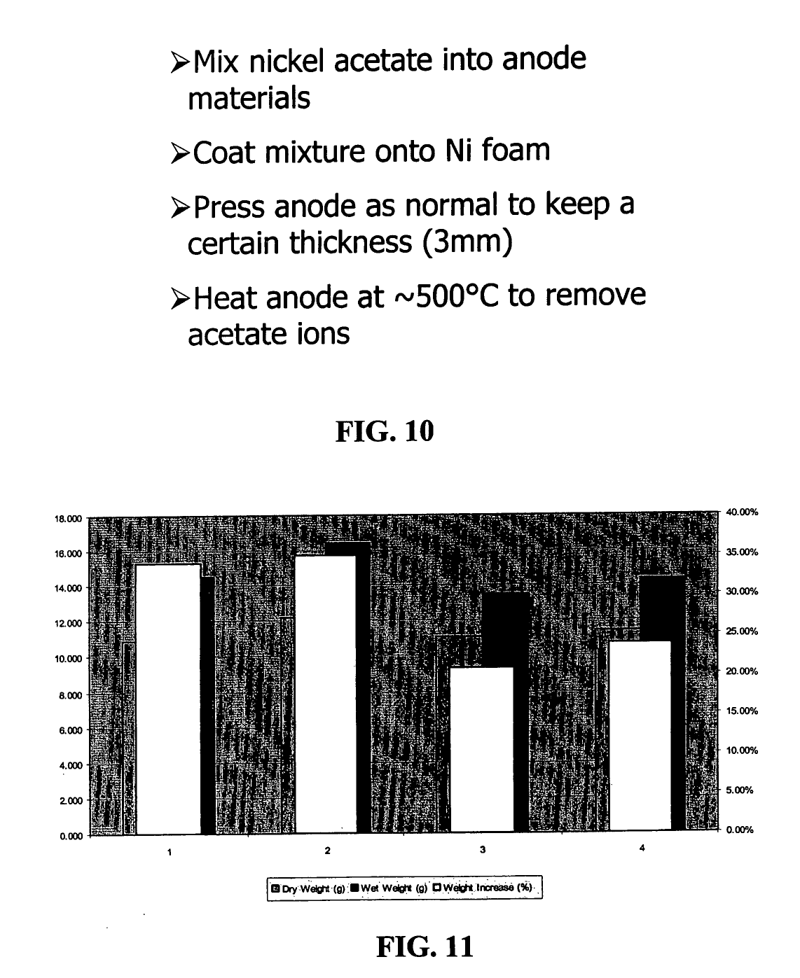

Another method 47 may be shown in FIG. 10. This embodiment may include mixing nickel acetate into anodic metal hydride material, coating the mixture onto a nickel foam plate to form an anode. The anode may be heated at 500 degrees Celsius to remove acetate ions and forms a porous anode with the removal scheme below. In another embodiment, the anode may be pressed to form an anode having thickness of about 3 millimeters (mm). The pressed anode may be heated at 500 degrees Celsius to remove acetate ions, for example with the removal scheme below.
Ni(CH₃COO)₂+H₂→Ni+C+CO₂+H₂O

The pore volume of the porous anode may be determined by selecting a quantity of sacrificial additive, such as aluminum and zinc that produce the pore volume. The mechanical strength of the porous anode may be determined by selecting the pressure and time of sintering. The sintering effect may be affected by controlling the temperature and the time of sintering. The sintering process may destroy or chemically alter the binders, such as polytetrafluoroethylene and carboxymethyl cellulose.

Hydrogen and oxygen are required by the fuel cell component to produce electrical energy. The rechargeable fuel cell may be operated with solid-state materials capable of hydrogen storage, such as, but not limited to, conductive polymers, ceramics, metals, metal hydrides, organic hydrides, a binary or other types of binary/ternary composites, nanocomposites, carbon nanostructures, hydride slurries and any other advanced composite material having hydrogen storage capacity.

Recharging of the rechargeable fuel cell may produce both water and oxygen. The produced materials may be recycled. The electrochemical system may require cooling and management of the exhaust water to function properly. The water produced by the fuel cell component may recharge the solid-state fuel. For some embodiments, the only liquid present in the rechargeable fuel cell may be water. Water management in the non-woven separation membrane 30 may be useful. Because the membrane may function better if hydrated, the fuel cell component may operate under conditions where the water by-product does not evaporate faster than it may be produced. The porous metal anode embodiments described herein may aid in the maintenance of membrane hydration.

The rechargeable fuel cell embodiment described herein applies to power generation in general, transportation applications, portable power sources, home and commercial power generation, large power generation and to any other application that would benefit from the use of such a system.

While a fuel cell/hydrogen generator hybrid design may be shown, it may be understood that other rechargeable fuel cell embodiments may include the porous metal hydride anode. The rechargeable fuel cell described may be operable for converting electrical energy into chemical energy, and chemical energy into electrical energy.

### EXAMPLES

Presented below are specific examples of methods for making porous metal hydride anode embodiments. These examples are presented to provide additional specific embodiments and not to limit embodiments of the invention.

### Example 1

A quantity of 10 grams (g) of as-received metal hydride alloy powder is mixed with 4.24 grams (g) of nickel acetate, to form a metal mixture. The metal hydride alloy powder MH is (AB₅: MmNi_{4.65}Co_{0.88}Mn_{0.45}Al_{0.05}) alloy powder. The metal mixture is added to 7.12 grams (g) of gel to form a metal gel mixture. The gel is made of polytetrafluoroethylene (PTFE) and carboxymethylcellulose, (CMC) added into water. Stirring the metal gel mixture at 500 RPM for 30 min forms a metal hydride (MH) slurry.

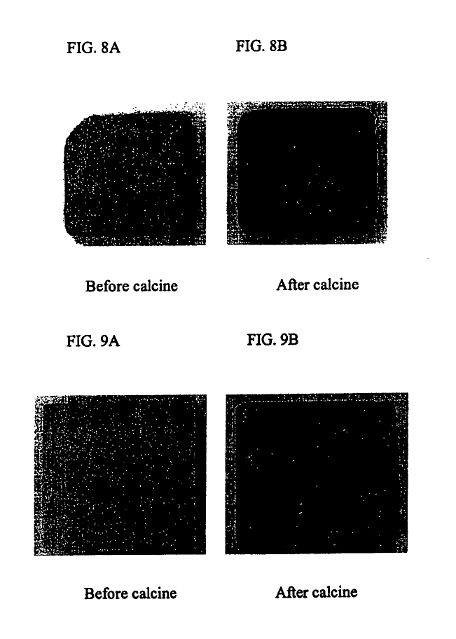

A thin film of the MH slurry is painted onto one surface of a clean 3×3 square centimeter plate. The plate is made of foamed nickel. The wet film is dried to a dry thin film layer at 80 degrees Celsius for 5 min. Another wet film of the MH slurry is prepared in the same way as described above and painted onto a surface on the other side of the same Ni foam plate. The second wet film is dried at the same conditions as the first wet film. The steps above are repeated with the slurry wet films, until a uniform dry film layer of a determined thickness is formed on both sides of the Ni foam to make a pellet. The pellet is then dried at 120 degrees Celsius in vacuum overnight to form a green pellet. Such a green pellet is shown as reference number 40 in FIG. 8A.

The green pellet is calcined in a tube furnace. After the calcinations, the porous calcined pellet appears black in color, as shown as reference number 42 in FIG. 8B. The process is repeated to form Samples 1 and 2.

### Example 2

A metal mixture is prepared and added to a gel as described in EXAMPLE 1. EXAMPLE 2 differs in that rather than 7.12 grams of gel, 5 grams of gel are added to form a metal gel mixture. The metal gel mixture is stirred and dried at 80 degrees Celsius. The stirring and drying processes is repeated until the metal gel mixture is evenly mixed and thoroughly dried.

Half of the dried mixture is added to a 3×3 square centimeters mold. A Ni foam plate having the same size as is used in EXAMPLE 1 is then added into the mold. The other half of the metal gel mixture is placed on the top of Ni foam plate to form a sandwich. The sandwich is pressed under determined conditions as indicated in Table 1. The procedure is repeated six times with differing pressing procedure for each of six samples to form Samples 3-8. A green pellet is obtained by pressing using the procedure. A pressing procedure is as follows:

TABLE 1
Pressing conditions to form the green pellet.

| Sample | Conditions |
|---|---|
| 3 | 2 Mpa, 2 min |
| 4 | 4 Mpa, 2 min |
| 5 | 6 Mpa, 2 min |
| 6 | 8 Mpa, 2 min |
| 7 | 10 Mpa, 2 min |
| 8 | 12 Mpa, 5 min |

The green pellet, such as the one shown in FIG. 9A is calcined in a tube furnace. After the calcinations, the pellet color is observed to be black, as indicate in FIG. 9B. The pressed sample is calcined by the following procedure:
1. Heat from room temperature to 450 degrees Celsius at 2 degrees Celsius per minute ramp rate, and maintained at 450 degrees Celsius temperature for 30 min.
2. Heated from 450 degrees Celsius to 500 degrees Celsius within 30 min, and kept at 500 degrees Celsius for 6 hours.
3. Cooled down to room temperature at a ramp rate of 5 degrees Celsius per minute.

As-prepared MH electrodes are weighed before put into 6 molar (M) potassium hydroxide (KOH) solutions. After soaking for 2 hours, the electrodes are each weighed to determine how much KOH is absorbed to the surface and into the pores.

FIG. 11 illustrates the weight increase of porous MH electrodes in 6 M KOH after 2 hours. Sample 1 and 2 are made via process 1/Example 1, and Samples 3 and 4 are made via process 2/Example 2. The weight increase of all the samples is more than 20 percent. The samples made via process 1 are able to absorb relatively more KOH solution.

In the description of some embodiments of the invention, reference has been made to the accompanying drawings which form a part hereof, and in which are shown, by way of illustration, specific embodiments of the invention which may be practiced. In the drawings, like numerals describe substantially similar components throughout the several views. These embodiments are described in sufficient detail to enable those of ordinary skill in the art to practice the invention. Other embodiments may be utilized and structural, logical, and electrical changes may be made without departing from the scope of the invention. The following detailed description is not to be taken in a limiting sense, and the scope of the invention is defined only by the appended claims, along with the full scope of equivalents to which such claims are entitled.

What is claimed is:

1. An electrode precursor, comprising:
a main body comprising a metal hydride and a sacrificial additive, and
the sacrificial additive being disposed in the main body to define an inner surface of the main body and further to define a pore volume, wherein
the sacrificial additive is present in an amount sufficient that, when removed, the pore volume of the main body is of sufficient volume to prevent or reduce water starvation in a fuel cell or in a battery in which an electrode formed from the electrode precursor is disposed.

2. The electrode precursor of claim 1, wherein the porous main body comprises one or more of nickel or cobalt.

3. The electrode precursor of claim 1, wherein the electrode is an anode.

4. The electrode precursor of claim 1, wherein the main body comprises one or more of an AB₅ alloy, AB₂ alloy, AB alloy, A₂B alloy, A₂B₁₇ alloy, or AB₃ alloy.

5. The electrode precursor of claim 4, wherein AB₅ alloy comprises one or more of LaNi₅, CaNi₅

6. The electrode precursor of claim 4, wherein AB₅ alloy comprises MAₓB_{y}C_{z},
wherein M is a rare earth element component;
A is one of the elements Ni or Co;
B is one of the elements Cu, Fe or Mn;
C is one of the elements Al, Cr, Si, Ti, V or Sn; and
x, y and z satisfy one of the following relations,
2.2≦x≦4.8, 0.01≦y≦2.0, 0.01≦z≦0.6, or
4.8≦x+y+z≦5.4.

7. The electrode precursor of claim 4, wherein the main body comprises one or more of an AB₂ alloy.

8. The electrode precursor of claim 7, wherein the AB₂ alloy is one of Zr—V—Ni, Zr—Mn—Ni, Zr—Cr—Ni, TiMn, or TiCr.

9. The electrode precursor of claim 4, wherein the main body comprises one or more of an AB alloy, and wherein the AB alloy is one of TiFe or TiNi.

10. The electrode precursor of claim 1, wherein at least a portion of the sacrificial additive is capable of being retained on the inner surface of the main body.

11. The electrode precursor of claim 4, wherein the A₂B alloy is Mg₂Ni.

12. The electrode precursor of claim 4, wherein the A₂B₁₇ alloy is La₂Mg₁₇.

13. The electrode precursor of claim 4, wherein the AB₃ alloy is one of LaNi₃, CaNi₃, or LaMg₂Ni₉.

14. The electrode precursor of claim 3, wherein the main body anode material comprises a catalyzed complex hydrides.

15. The electrode precursor of claim 14, wherein the catalyzed complex hydrides comprise one or more of borides, carbides, nitrides, aluminides, or silicides.

16. The electrode precursor of claim 14, wherein the catalyzed complex hydrides comprise an alanate.

17. The electrode precursor of claim 16, wherein the alanates comprises one or more of NaAlH₄, Zn(AlH₄)₂, LiAlH₄ or Ga(AlH₄)₃.

18. The electrode precursor of claim 15, catalyzed complex hydrides comprise one or more borohydrides selected from the group consisting of Mg(BH₄)₂, Mn(BH₄)₂, and Zn(BH₄)₂.

19. An electrode formed by removal of the sacrificial material from the electrode precursor defined in claim 1.

20. The electrode of claim 19, wherein the main body has a pore volume of greater than 5 percent.

21. A fuel cell or battery comprising the electrode of claim 19.

22. A rechargeable fuel cell, comprising:
a hydrogen generator comprising the electrode of claim 19; and
a fuel cell that shares the electrode of claim 19 with the hydrogen generator.

23. A method, comprising:
mixing a metal hydride and sacrificial material to form a mixture;
applying the mixture to metal substrate to form a main body; and
removing the sacrificial material to form a porous electrode.

24. The method of claim 23, further comprising mixing a binder with the metal hydride and the sacrificial material.

25. The method of claim 23, wherein the metal substrate is nickel foam.

26. The method of claim 23, wherein removing comprises sintering the main body.

27. The method of claim 26, wherein the sintering is a paste sintering.

28. The method of claim 26, wherein the sintering is a cold press sintering.

29. The method of claim 23, wherein the removing of the sacrificial material is by alkaline dissolving.

30. The method of claim 23, wherein the removing of the sacrificial material is by sonication.

31. The method of claim 23, wherein the removing of the sacrificial material is by heat decomposition.

32. The method of claim 23, wherein the removing of the sacrificial material is by acid dissolving.

33. The method of claim 23, wherein the sacrificial material is added in an amount that is effective for making a porous electrode having a pore volume of greater than about 5 percent.

34. The method of claim 23, further comprising pressing the main body to form an anode having a determined thickness.

35. A system, comprising:
means for forming an electrode; and
means for forming pores in the electrode.

36. The system of claim 35, further comprising a catalyst disposed in the means for forming the pores, wherein the catalyst is capable of deposing on an inner surface of the electrode after the pores are formed in the electrode.
